(19) United States
(12) Patent Application Publication
(10) Pub. No.: US 2014/0040832 A1
(43) Pub. Date: Feb. 6, 2014

(54) SYSTEMS AND METHODS FOR A MODELESS 3-D GRAPHICS MANIPULATOR

(71) Applicant: Stephen Regelous, (US)

(72) Inventor: Stephen Regelous, Bangkok (TH)

(73) Assignee: Stephen Regelous, Bangkok 10110 (TH)

(21) Appl. No.: 13/952,593

(22) Filed: Jul. 27, 2013

Related U.S. Application Data
(60) Provisional application No. 61/694,135, filed on Aug. 28, 2012.
(60) Provisional application No. 61/678,636, filed on Aug. 2, 2012.

(51) Int. Cl. G06F 3/0481

(52) U.S. Cl. CPC G06F 3/04815
USPC 715/849

(57) ABSTRACT

One aspect provides a modeless manipulator for interacting with and manipulating virtual objects located in 3-D space, in applications such as CAD. The modeless manipulator provides user interface elements that can be accessed by a user to effect any interaction relevant within the current display of the 3-D object. Examples of such interactions include scaling, rotation and translation in any of the three coordinate directions, scaling in all three coordinate directions, orbital rotations, and translation in screen space. The user interface elements of the manipulator are rendered so to ease usage of the manipulator on small form factor displays and with machines that lack mouse and stylus as mechanisms for user input. These aspects can be embodied in such machines, which can perform processes that are determined according to tangible machine readable media storing machine executable instructions describing such processes.

### CROSS-REFERENCE TO RELATED APPLICATIONS

This application claims priority from U.S. Provisional Pat. App. No. 61/678,636, entitled “SYSTEMS AND METHODS FOR A MODELESS 3-D GRAPHICS MANIPULATOR”, filed on Aug. 2, 2012 and from U.S. Provisional Pat. App. No. 61/694,135, entitled “SYSTEMS AND METHODS FOR A MODELESS 3-D GRAPHICS MANIPULATOR” and filed on Aug. 28, 2012, both of which are hereby incorporated by reference in their entireties for all purposes.

### BACKGROUND

1. Field

In one aspect, the following relates to an on-screen manipulator for a user to interact with a 3-D graphics model, and in one particular example, to an on-screen manipulator for allowing a user to interact with an object or objects in an application using 3-D graphics modelling.

2. Related Art

A modal 3D manipulator widget in a computer animation program, CAD program, visual effects program, or engineering program, such as AutoCAD, Maya, Blender, or Houdini provide a means to perform a function, such as translate, rotate and scale, on a selected object or objects in a selected 1 or more degrees of freedom.

### SUMMARY

In one aspect, there is provided a modeless manipulator that provides simultaneously active manipulator components, for functions including translate (3-D and screen space), rotate, scale, all-scale, and orbital rotations that combine multiple degrees of freedom. The modeless manipulator is beneficially used on tablet devices or through user interfaces that may provide comparatively low resolution displays, which may have a touch screen user interface, and which may not have a high-precision input mechanism such as a mouse, or stylus.

A modeless manipulator according to the disclosure can be implemented using computer executable instructions and data obtained from computer readable media. These instructions and data provide for display of a manipulator in which all relevant controls can be accessed by interaction with User Interface (UI) elements that are part of the manipulator, so that mode selection commands are not required. The UI elements can be drawn with sizes and relative positions appropriate for a tablet.

In some examples, the manipulator is drawn on the display at a fixed size, which can be selected relative to the size of the display. In one implementation, the manipulator uses a substantial portion of a display of limited size. For example, on a 9 or 7 inch tablet display, the manipulator may occupy several square inches of display space, for example 4, 6, 8, 9, or 12 square inches, or more. The fixed size of the manipulator may be adjusted by a user. An opacity of the elements of the manipulator also may be adjusted or selected, such that an object or objects being manipulated can be viewed through the elements of the manipulator. In effect, a manipulated object may appear as a different size on the display, but the manipulator itself may still be a fixed size presented on the display.

In an example aspect, the elements of the manipulator occupy 2-D screen space of sufficient dimension to facilitate interaction by a user that does not have a precise mechanism for user input, such as a mouse or stylus. For example, on a touch screen, the 2-D screen space occupied by the elements of the manipulator are thick enough for interaction with a finger or fingers.

Visual feedback for some interactions with user interface elements may be provided by showing a difference in size of the manipulator. For example, translating to move an object farther from a camera may be best depicted by making the manipulator size smaller on a display. However, upon effecting the change, the manipulator can again be resized to a default size and/or position.

### BRIEF DESCRIPTION OF THE DRAWINGS

Aspects of the disclosure are detailed with examples, in accordance with the following figures, in which:

FIG. 1 depicts a first view of an example manipulator;

FIG. 2 depicts a view of the manipulator of FIG. 1, where elements of the user interface of the manipulator for scaling an associated object are identified;

FIG. 3 depicts a view of the manipulator of FIG. 1, where elements of the user interface of the manipulator for translation of an associated object are identified;

FIG. 4 depicts a view of the manipulator of FIG. 1, where elements of the user interface of the manipulator for scaling an associated object are identified;

FIG. 5 depicts a view of the manipulator in accordance with FIG. 4, and where elements of the user interface of the manipulator for scaling have indicators of a direction of scaling

FIG. 6 depicts an example method of receiving input through a manipulator in accordance with the disclosed examples, and processing same;

FIG. 7 depicts an example system in which manipulators according to the disclosure can be implemented; and

FIG. 8 depicts an example of a display for a system in which manipulators according to the disclosure can be implemented.

### DETAILED DESCRIPTION

Manipulators according to the disclosure can be used for editing and controlling the viewing of graphical objects in 3-D graphics design tools, for example. Because this disclosure relates to computer graphics, computer aided design and computer aided visualization, for example, when the disclosure refers to an ‘object’, it refers to a representation or digital design determined from data, and that can be used to render a display of a shape or shapes, which represent the object. In general, such shapes are defined in 3-D space, and they can be viewed from an arbitrary perspective and manipulated in a variety of ways.

In more detail, a graphical object can be defined using definition data that defines a location in a virtual 3-D space where the object is placed. A variety of objects can be manipulated by a manipulator according to the disclosure. Some objects have an outer surface and may also have data used to define a visual appearance of the surface. Other objects may be defined by splines, points, patches, polygon outlines, object placement indicators, and so on. Graphical objects can be components of other objects or assemblies of objects. A wheel of a car is an example of a graphical object; such wheel can be part of an assembly of objects that define the car. More sophisticated usages of objects can include designing a building, a landscape, or other complex 3-D space, many objects, of various complexities. These examples of objects are provided for context, and not by way of limitation as to the kinds of features or objects that can be manipulated using a manipulator according to the disclosure.

During viewing, editing, or creating graphical objects, or using such graphical objects to make an assembly of objects, or a 3-D scene with such objects, user interaction fmay be required in order to control features of the objects, such as size, orientation and position, or control how the object is being viewed within an editing program. For example, in a 3-D scene, one or more lights may emit light into the scene, and a camera position may be defined to render the scene from a particular viewpoint. A user may desire to move a viewpoint to observe how the object appears from different perspectives.

To aid in these activities, a manipulator object may be provided that is associated with an object, and can be overlayed, from a projection from which the object is being viewed, on the object. Stated differently, within the context of 3-D rendering, an object is located in a 3-D space, and is viewed from a viewpoint. In order to render a 2-D representation of the object, the object can be perspective transformed into a 2-D screen coordinate system, and a set of pixels in an image being rendered can be shaded according to the location and surface characteristics of the object. In other situations, a current view may be orthographic. More generally, a camera projection matrix can be used for perspective and non-perspective views, in order to determine how objects to be manipulated will be mapped to screen space. Manipulators according to the disclosure can be used to manipulate any such objects. A manipulator is placed closer (at shallower depth) to the viewpoint than the object being manipulated; such placement of the manipulator can be accomplished by compositing the manipulator with underlying scene object(s). The manipulator itself is rendered as a part of the 2-D image to be displayed.

In a modal manipulator, only a subset of the functionality is available at any one time, for example, only translation may be available or a larger subset of operations, such as translation, rotation, and scaling. However, these manipulators do not provide access to all relevant transformations at one time through the elements of the manipulator itself. A further limitation of prior art is that these manipulators are not well-suited for use on a tablet device, as they require a user to accurately click and drag on specific small features of the manipulator, which makes them difficult to use on devices with limited display sizes or where the user is not using a stylus or mouse. For example, using conventional manipulators on a touch-screen tablet proves awkward and reduces productivity of an artist. Some aspects disclosed herein relate to a manipulator that avoids modal behaviour and is more suitable for use on tablet or other small screen form factor devices.

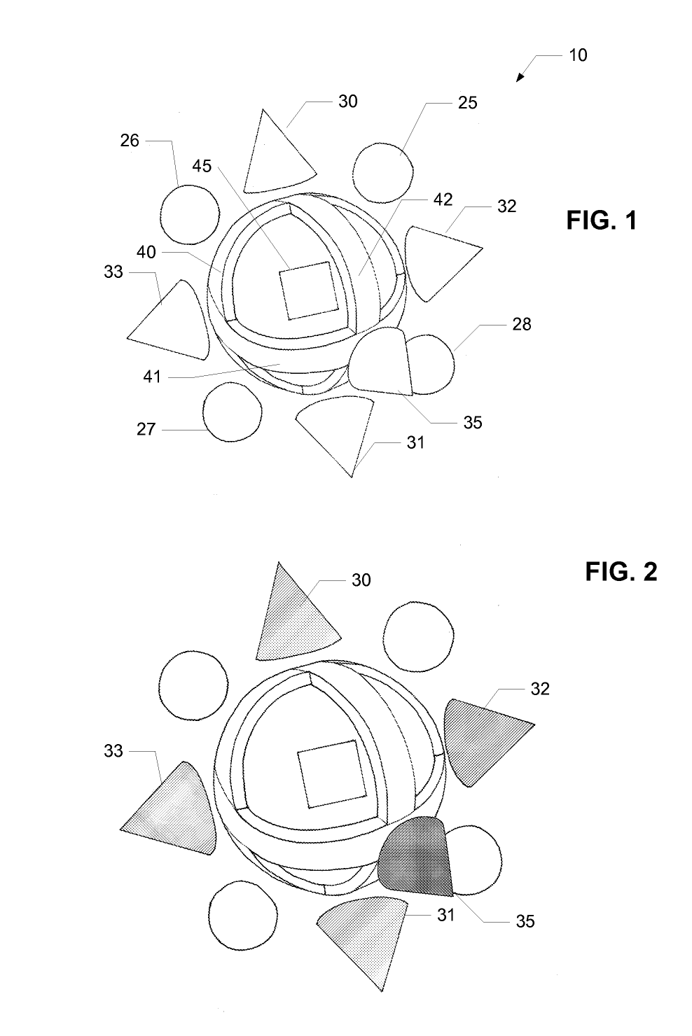

FIG. 1 depicts an example of a modeless manipulator 10. Manipulator 10 can be displayed on a display of a computer system. As introduced above, manipulator 10 is displayed on a display, in association with an object to be manipulated by input received through manipulator 10. In some exemplary aspects, manipulator 10 is for use with computer systems that have small form factor displays, touch screens, and which may be interacted with by users without mouse or stylus on a regular basis.

As used here, available for selection at one time, or simultaneously, refers to a concept where a user interface feature can be used without requiring another input, such as a mode key selection or some other kind of side-band user input. For example, it may be possible to selectively engage one of translation, rotation and scaling from displayed user interface elements of the manipulator.

Manipulator 10 has a set of user interface elements, which are used to accept inputs to effect a variety of manipulations on an associated object. Examples of manipulations include translation, rotation, and scaling. Each of these manipulations are accommodated within a 3-D space. Additionally, some manipulations can have effect also within a screen space, including translation. The following disclosure relates examples of how these user interface elements can be displayed and be used in manipulators according to the disclosure.

In the example manipulator 10 of FIG. 1, 2-D cones 30-31 are provided to accept translation inputs, which indicate that an associated object is to be translated in 3-D space in a specific direction, along a specific coordinate axis. For example, cones 30 and 31 respectively control translation in each direction along one axis, and cones 32 and 33 respectively control translation in each direction along another axis. Cone 35 is provided for translation in a direction indicated by the tip of the cone; a cone corresponding to cone 35 (pointing in a direction opposite from cone 35) faces away from the current viewpoint and is obscured by manipulator 10. For example, translation can be performed by selecting and dragging any one of the cone components. In a situation where manipulator 10 is used on a tablet display or touch screen, selecting can include a touch gesture, where contact (e.g., a finger contact) is maintained on the display, followed by translation of the finger in a appropriate direction on a surface of the display. In order to simplify a visual appearance of manipulator 10, a transparent sphere can be drawn within the volume defined by sweeping the arcs 40-42. For example, a rear portion of arc 42 is concealed in such manner; other approaches to concealing manipulator elements that face away from a current viewpoint may be implemented.

FIG. 2 depicts that each set of cones can be assigned a respective color or other distinguishing pattern. For example, red cones can be used for translation along the X axis, green cones for translation along the Y axis, and yellow cones for translation along the Z axis. These color assignments are exemplary, and those of ordinary skill would be capable of selecting different color assignments. Additionally, other visually distinguishing characteristics can be used, and those of ordinary skill would be able to select one of more distinguishing characteristics for a particular implementation. As will be apparent from the disclosure below, colors or other visual characteristics assigned to each axis are maintained for other user interface elements for different manipulations, such that the interface is consistent with respect to a set of user interface elements that effect manipulations for one axial direction.

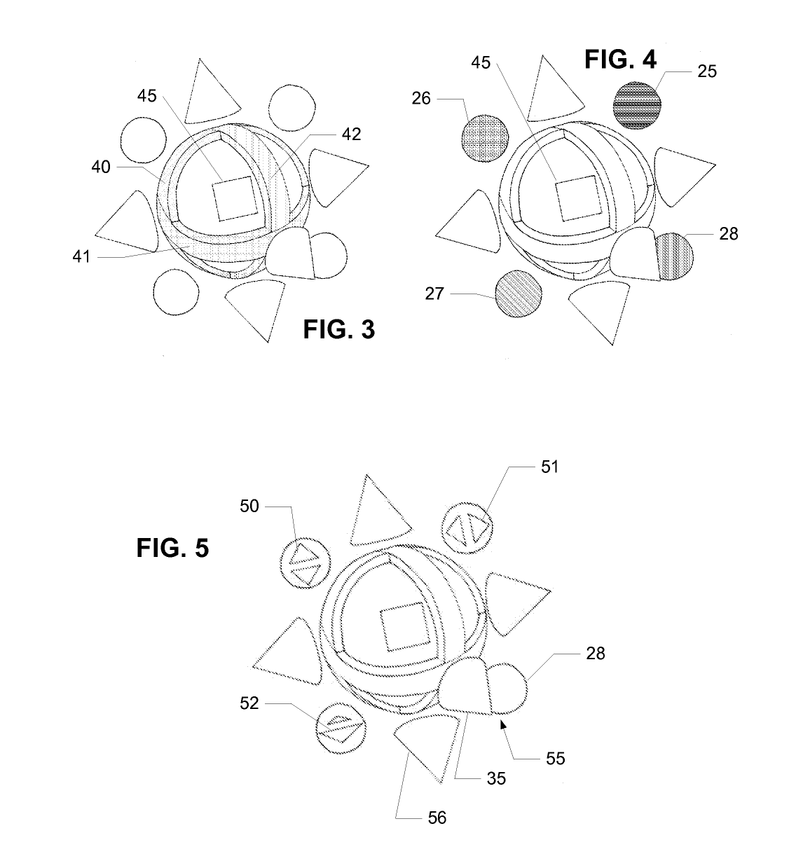

In manipulator 10, rotation is achieved by selecting and dragging on any one of spherical arc elements 40-42. Each element 40-42 can be assigned a color or user interface characteristic consistent with that assigned to respective translation cones 30-33, described above. For example, red can be assigned for rotation about the X axis, green for rotation about the Y axis and yellow arc for rotation about the Z axis. In the examples of FIG. 2 and FIG. 3, cones 32 and 33 are for translation in the X axis, and thus, arc element 42 is for rotation about the X axis. Similarly, cones 30 and 31 are for translation in the Y axial direction, and so arc element 41 is for rotation about the Y axis.

In FIGS. 1-4, a square 45 is depicted at a center of a sphere defined by spherical arc elements 40-42. Square 45 can be selected and dragged as a way to translate the object in screen space. As introduced above, an object being manipulated is located in a 3-D space, but can be perspective transformed into a 2-D image plane, in accordance with a current perspective (or be orthographic, as another example). So, dragging the object in screen space is translated into a movement in 3-D space in accordance with a transformation matrix that was used to transform the object into the 2-D image plane. In this example, white square 45 can obscure a translation user interface element that is effectively along an axial direction parallel with a current viewing direction. Therefore, the screen space translation element obscures a user interface element that does not serve a useful purpose, given a current viewing direction.

FIG. 4 depicts circles 25-27, which can be used for scaling the object in a selected coordinate direction. As with the orbital and translation disclosures above, each circle 25-27 can be given a color in accordance with a respective coordinate direction. Circle 28 can be selected in order to perform an all-scale manipulation, which uniformly scales the object in all coordinate spaces simultaneously. Any of circles 25-28 can be selected by a finger touch, for example, and an amount of scaling determined in accordance with a distance that the touching finger was dragged.

In some implementations, circles 25-28 are always displayed as flat 2-D circles on a display (as opposed to being modeled as 3-D components that are perspective transformed and which would cause such components to appear in a manner depend on viewing perspective.

A location of manipulator 10 can be determined based on an object (or a discrete portion of an object) to be manipulated. In one approach, manipulator 10 is centered in 3-D space on an object to be manipulated. Manipulator 10 also could be centered on an axis and positioned along an object to be manipulated. In some approaches, components of the manipulator are drawn in front of the object to be manipulated, so that the manipulator components obscure the object (where they are in a line of sight). Portions of the object can be visible where components of manipulator 10 are not present. In one approach, manipulator components that are rear-facing are not shown. One way to implement this feature is by drawing a transparent sphere or shell that is within the spherical shell defined by the outer spherical arc elements 40-42. A degree of transparency of elements of manipulator 10 can be selected, so that a visibility of selected object(s) through these elements can be controlled.

FIG. 5 depicts that circles 25-27 can have arrows 50-52 that depict a direction in which scaling can be achieved with each circle. In other implementations, arrows according to the example of arrows 50-52 can be provided, without being enclosed in circles 25-27.

In the above disclosures, user interface elements were defined or otherwise demarcated by some closed-form surface area (e.g., circles 25-28). However, a user interface element can be defined by white space, between or among these explicitly demarcated user interface elements. For example, selecting and dragging on space between arcs 40-42 can be used for arbitrary orbital rotation in a direction determined according with a direction of the dragging.

In some implementations, circles 25-28 are always drawn in a square arrangement facing the user, such that they appear outside the spherical components in screen space. In further detail, manipulator 10 can be defined as a 3-D object in the 3-D space, and thus, can be rotated and the like, as can objects being designed or used in the 3-D space. Where any of circles 25-28 would be concealed by another part of manipulator 10, that circle or circles can be relocated. FIG. 5 provides an example where circle 28 is partially obscured by cone 35, as indicated generally by arrow 55. In some implementations, circle 28 is located/relocated to avoid circle 28 being obscured.

FIG. 5 also depicts (as do other figures) the concept that manipulator 10 can have some elements drawn in perspective and other elements that are drawn flat. For example, cone 35 can be seen as being drawn in perspective, when compared with cone 56 and with circle 28. Thus, some elements of manipulator 10 can be drawn in 2-D space (as opposed to being defined in 3-D space and transformed according to perspective), which can aid in ensuring that those elements are available for interaction, for all dimensions, regardless of an orientation of manipulator 10.

In some aspects, a user interface element can be used to obscure components of the manipulator that would allow for actions that do not make sense given the current 3-D viewpoint. In example manipulator 10, white square 45 provides a user interace element to be used to effect translation in screen space. In this example, the white square is always drawn in front, such that it obscures manipulator components that overlap screen space. White square 45 can be drawn in front by drawing the white square as opaque and after drawing other elements of the display; in this example, depth testing is not required. In another approach, white square 45 can be given a shallower depth, where depth testing would be used. White square 45 is intended to be rendered at a center of manipulator 10 in 3-D space, and is drawn flat in screen space.

Additionally, controls can be provided for adjusting opacity of elements of manipulator 10, a size of manipulator 10 in screen space, and thickness of elements of manipulator 10. Manipulator 10 can be made to appear in any of a variety of ways. For example, manipulator 10 can default to always appear or not when an object is selected. If manipulator 10 does not appear automatically, it can be switched on by a hotkey (in the case of an appropriate keyboard—virtual or physical), an on-screen button, selecting from a menu, and so on. Manipulator visibility preferences can be carried through a session, and then reset or stored in a more permanent configuration.

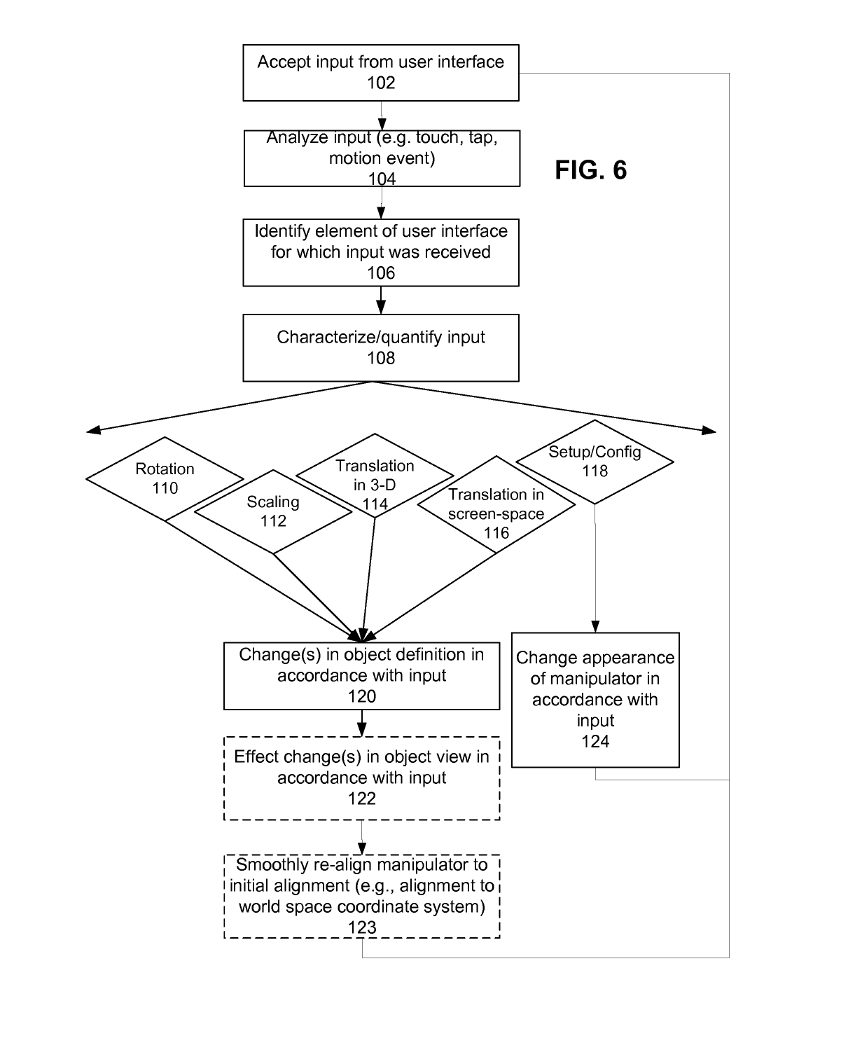

FIG. 6 depicts an example process for processing input received by using manipulator 10. At 102, input from a user interface is accepted. For example, touch input is accepted through a touch screen. Such input may comprise a location on the touch screen where the input is received, and a type of input, such as a single touch, followed by dragging. At 104, such input is analyzed and outputs of the analysis are used at 106 to identify which element or elements of manipulator 10 was used and at 108, that interaction is characterized and quantified. For example, a touch location is determined, and that touch location is used to determine what element of manipulator 10 (if any) was engaged by that touch. An amount and direction of swiping is determined and used to characterize a change to be made in accordance with the element of manipulator 10 that was engaged. In summary of the example disclosures of manipulator functionality, inputs that can be extracted from the characterized/quantified input 108 include rotation 110, scaling 112, translation in 3-D 114, translation in screen space 116, and setup/config 118 inputs. At 120, change(s) in a definition of an object (as represented by stored data that can be interpreted by the tool for which manipulator 10 is being used), and at 122, change(s) can be made in how the object is being viewed in accordance with input. In some cases, for a given input, only one of 120 and 122 will be performed, in that some kinds of inputs can be effected either by changing an object definition or by re-rendering a view of the object (and/or the manipulator). In some implementations, manipulator 10 does not provide for changes in the view of an object (e.g., rotating or moving the object relative to the camera) and instead, all interactions with manipulator elements affect some aspect of the definition of the object. For example, data defining the object may be changed, but depending on specifics of the scene, viewpoint, and the manipulator, the actual display may or may not change (or change appreciably). For setup/config 118, a Graphical User Interface (GUI) can be provided for controlling how manipulator 10 appears, and inputs received through the GUI are implemented at 124 by changing the appearance of the GUI in accordance with the inputs. For example, line widths, color assignments and opacity can be controlled.

At 123, manipulator 10 can be smoothly returned to an initial alignment after completion or after gesture release. For example, an initial alignment of manipulator 10 can be an alignment to world space coordinates. For example, whenever a user begins to interact with manipulator 10, it is aligned with world space. When a user releases manipulator 10, e.g., by lifting a finger from a current position on a touch screen, then manipulator 10 is made to gradually return to this initial alignment. In one example, manipulator 10 can be made to take 0.50 seconds to return to the initial alignment. The re-alignment can be effected as a smooth rotational change. In one example, a quaternion interpolation, such as a quaternion spherical linear interpolation, is used to determine intermediate positions for manipulator 10 between the alignment of the manipulator when re-alignment is to commence, and the initial alignment, to which manipulator 10 is to be returned. Other variations are possible, in that manipulator 10 can be made to rotate serially in each dimension. An amount of time required to return manipulator 10 to initial alignment can be adjustable, such as a value selected from between 0.1 to 0.5 seconds. This time can be user-selectable, or a system parameter selected by a designer of the implementation. Those of ordinary skill can determine an approach to smoothly re-aligning manipulator 10 according to the above examples.

In summary of a particular example, a user can begin to interact with manipulator 10, when it is in the initial alignment (such as alignment with world coordinates), interact with manipulator 10 to cause manipulator 10 to no longer be in such initial alignment in order to effect an operation on an object associated with manipulator 10. When that interaction is completed, manipulator 10 smoothly returns to the initial orientation, which can be effected by determining an ordered set of intermediate orientations for manipulator 10, using quaternion spherical linear interpolation and then iteratively repositioning manipulator at each intermediate orientation in the ordered set. Of course, the entire set of intermediate orientations does not need to be defined in advance, so long as a subsequent orientation is available when it is needed. It should be understood that each orientation is used to redraw manipulator 10, which can include a geometry setup followed by rendering of a 2-D image for manipulator 10. In some aspects disclosed above, some elements of manipulator 10 are displayed flat regardless of what kind of projection is being used (e.g., orthographic versus perspective), such as the scaling circles 25-28. These elements would not be made to be subjected to the re-alignment described above.

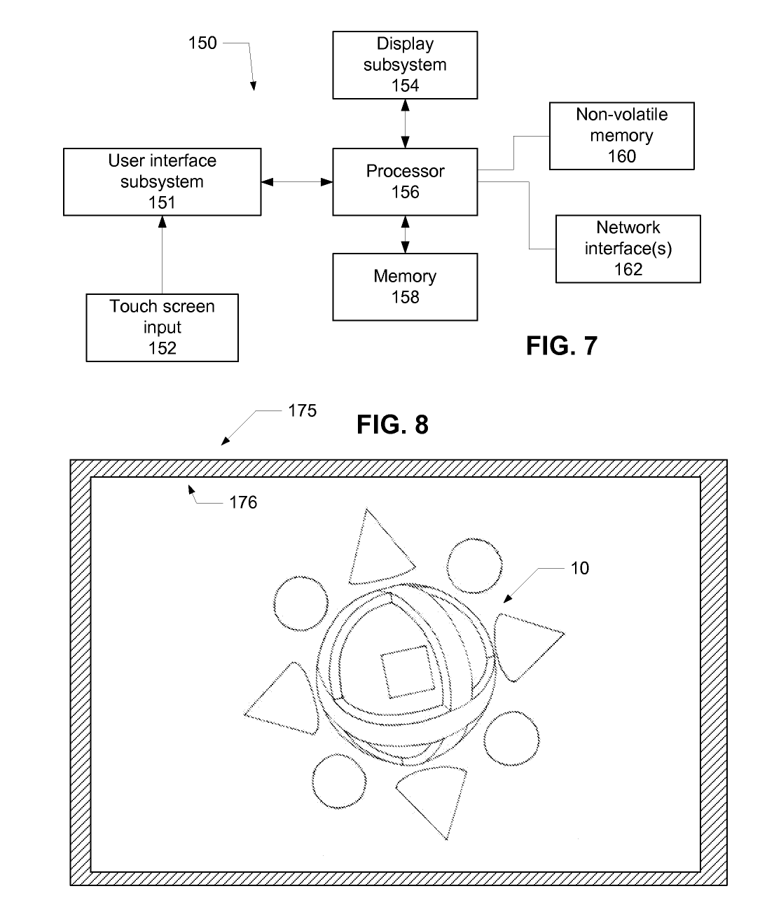

FIG. 7 depicts aspects of an example system 150, which includes a processor 156, which communicates with a memory 158, a user interface subsystem 151 which receives input from a touch screen input 152. Processor 156 communicates with display subsystem 154, in order to display images. Processor 156 also can communicate with a non-volatile memory resource 160, which can provide storage for configuration data, and programs that are used to configure processor 156 to perform implementations of the process depicted in FIG. 6 and implement the disclosures herein. Processor 156 also can communicate with network interface(s) 162 in order to send and receive data through a variety of networks, and can include wireless networks, including cellular networks, and local area network (WiFi) networks.

FIG. 8 depicts an example of a table 175 with a display 176, which displays manipulator 10. FIG. 8 depicts an example in which manipulator 10 uses a relatively large portion of the available area of display 176.

I claim:

1. A system, comprising:
a processor;
a display capable of displaying an image;
a non-transitory memory storing machine executable instructions for configuring the processor to perform a method comprising:
displaying a manipulator on the display, in association with a displayed 3-D virtual object, the 3-D virtual object being displayed from a current point of view defined in 3-D space, the manipulator comprising user interface elements for a set of currently available object manipulations, all of which are available to be selected solely by interaction with the displayed user interface elements;
accepting input indicative of interaction with one or more of the displayed user interface elements;
determining an effect of the accepted input on one or more of the position, size, and orientation of the 3-D virtual object in the 3-D space;
updating data defining the 3-D virtual object stored in the tangible memory; and
refreshing the display.

2. The system of claim 1, wherein the set of currently available object manipulations comprise rotation in each of three canonical directions in a 3-D coordinate system, translation in each of the three canonical directions, free orbital rotation in a combination of the three canonical directions, scaling in each of the three canonical directions, and simultaneous scaling in all of the three canonical directions.

3. The system of claim 1, wherein the user interface elements of the manipulator comprise an inner section for inputs relating to rotation, and four interface elements disposed outside of the inner section, a respective one of the four interface elements allocated to scaling in one coordinate direction of the 3-D space, and the remaining interface element of the four is allocated to scaling in all three of the coordinate directions within the 3-D space simultaneously.

4. The system of claim 3, wherein the three user interface elements allocated to scaling in respective coordinate directions each comprise an indication, displayed within the interface element, of a direction of scaling for that user interface element.

5. The system of claim 3, wherein the four interface elements allocated to scaling are distributed at 90 degree intervals in the plane of the display.

6. The system of claim 3, wherein the four interface elements are circular and are distributed at 90 degree intervals relative to each other in the plane of the display.

7. The system of claim 3, wherein three of the four interface elements allocated to scaling are each assigned a respective color associated with the 3-D coordinate direction allocated to that user interface element, and the user interface element allocated to scaling in all three of the coordinate directions simultaneously is drawn with an interior color that is one of white and a background color.

8. The system of claim 1, wherein one or more of the user interface elements are displayed flat in 2-D screen space on the display, regardless of a projective transformation being applied to at least one other user interface element.

9. The system of claim 1, wherein the display is capable of receiving touch inputs, and all input indicative of interaction with the displayed user interface elements is received through touch inputs.

10. The system of claim 1, wherein the user interface elements of the manipulator comprise a square feature, drawn at a center of the manipulator, and opaque with respect to user interface elements of the manipulator behind the manipulator in 3-D space, with respect to a current viewer position, wherein the square feature is provided to accept user input for translation of the 3-D object in screen space.

11. A machine implemented method for accepting user interaction with 2-D depictions of 3-D graphics objects, comprising:
displaying, on a display, a 2-D depiction of an object defined in a 3-D coordinate space, according to definition data for the object stored on a tangible machine readable medium;
displaying a manipulator comprising a plurality of interface elements, each for receiving inputs from a user, the displaying of the manipulator comprising presenting the manipulator in a fixed size relative to a size of the display, wherein the manipulator obscures portions of the 2-D depiction of the object and the elements have a user-selectable opacity;
receiving inputs through one or more of the plurality of interface elements;
and updating one or more of the definition data of the object according to the accepted input and the 2-D depiction of the object displayed on the display.

12. The method for accepting user interaction with 2-D depictions of 3-D graphics objects of claim 11, wherein the plurality of user interface elements comprise four 2-D drawn circles for accepting scaling inputs, indicating scaling in each coordinate direction of a mutually orthogonal 3-D coordinate system, and an all-direction scaling operation.

13. The method for accepting user interaction with 2-D depictions of 3-D graphics objects of claim 11, wherein the plurality of user interface elements comprise 3-D conical elements drawn in perspective along each direction of a mutually orthogonal 3-D coordinate system.

14. The method for accepting user interaction with 2-D depictions of 3-D graphics objects of claim 11, wherein the 3-D conical elements comprise a respective pair of 3-D conical elements pointing in opposite directions along one or more of the directions of the mutually orthogonal 3-D coordinate system.

15. The method for accepting user interaction with 2-D depictions of 3-D graphics objects of claim 11, wherein the plurality of user interface elements comprise an opaque centrally drawn element for accepting translation in screen space inputs.

16. A non-transitory machine readable medium storing machine executable code for programming a machine to perform a method, comprising:
displaying, on a display, a depiction of an object defined in a 3-D coordinate space, according to definition data for the object stored on a tangible machine readable medium;
displaying a depiction of a 3-D manipulator on the display, the depiction comprising a set of user interface elements for accepting user input to manipulate one or more of a position, orientation, and size of the object, in any of the three coordinate directions of the 3-D coordinate space, individually, or concurrently;
accepting input through interaction with any user interface element of the 3-D manipulator; and
updating the definition data of the object according to the accepted input.

17. The non-transitory machine readable medium storing machine executable code for programming a machine to perform a method of claim 16, wherein the displaying of the depiction of the 3-D manipulator comprises displaying one or more of the user interface elements consistent in size and position in a 2-D plane of the display, irrespective of a current position of the 3-D manipulator with respect to a viewpoint of the display.

18. The non-transitory machine readable medium storing machine executable code for programming a machine to perform a method of claim 16, wherein the method further comprises accepting input to configure how one or more elements of the 3-D manipulator are depicted on the display.

19. The non-transitory machine readable medium storing machine executable code for programming a machine to perform a method of claim 16, further comprising displaying the depiction of the object in accordance with a camera projection matrix applied to the definition data for the object, and displaying user interface elements for accepting rotation manipulations according to the camera projection matrix.

20. The non-transitory machine readable medium storing machine executable code for programming a machine to perform a method of claim 16, further comprising displaying the depiction of the object in accordance with a camera projection matrix applied to the definition data for the object, and displaying the position user interface elements according to the perspective projection, and displaying a scaling user interface element without being transformed by the perspective projection.

21. The non-transitory machine readable medium storing machine executable code for programming a machine to perform a method of claim 16, wherein the camera projection matrix defines an orthographic projection, and the method further comprising displaying translation user interface elements according to the orthographic projection, and one or more of the translation user interface elements and the rotation user interface elements are displayed without being transformed by the orthographic projection.
